(19) United States
(12) Patent Application Publication
(10) Pub. No.: US 2023/0347808 A1
(43) Pub. Date: Nov. 2, 2023

(54) POWERED RAIL SYSTEM

(71) Applicant: WARNER CO., West Middlesex, PA (US)

(72) Inventors: Mohammed Irfan, Concord, NC (US); Milos V. Coric, Lincolnshire, IL (US); Emily Kern, Elmhurst, IL (US); Jonathan David Monge, Lake Geneva, WI (US); Michael Bykowski, Lindenhurst, IL (US); Thomas Ward Parker, Jamestown, PA (US)

(21) Appl. No.: 18/142,396

(22) Filed: May 2, 2023

Related U.S. Application Data
(60) Provisional application No. 63/337,295, filed on May 2, 2022.

(51) Int. Cl. B60P 1/64; B60P 7/08

(52) U.S. Cl. CPC B60P 1/649; B60P 7/0815; B60P 1/6427

(57) ABSTRACT

A powered rail system is disclosed. The rail system is mountable on a truck bed, to which various accessories may be attached, and to which various electronic devices may be connected. The rail system includes first and second side rails, where the first and second side rails are substantially parallel and separated by a width, and where each side rail includes a front end, a back end, and a body extending between the front end and the back end. The rail system further includes a storage structure secured thereto, a first outside surface adjacent to the body of the first side rail, and a second outside surface adjacent to the body of the second side rail.

### CROSS-REFERENCE TO RELATED APPLICATION

The present application claims priority to provisional U.S. Application No. 63/337,295 filed May 2, 2022, the contents of which are hereby incorporated by reference in their entirety.

### BACKGROUND

### A. Field

This disclosure relates generally to a rail system, and more particularly to a powered rail system that is mountable on a truck bed, to which various accessories, such as toolboxes or ladder racks, may be attached, and to which various electronic devices, such as power tools or batteries, may be connected.

### B. Description of Related Art

Trucks and other similar vehicles typically carry a number of electric power tools, such as rechargeable battery operated tools and accessories, to and from job sites and similar locations. However, when the truck arrives to a jobsite, those accessories (as well as accessories already present at the jobsite) require access to a power supply in order to charge and function. A means for charging power tools, cooling units, batteries, and other accessories on a truck would be desired, while simultaneously providing truck owners with greater flexibility when positioning various accessories (both electronic and non-electronic) in the truck.

### SUMMARY

The following embodiments and aspects thereof are described and illustrated in conjunction with systems, tools and methods which are meant to be exemplary and illustrative, not limiting in scope.

In one aspect, a rail system is disclosed. The rail system comprises first and second side rails, where the first and second side rails are substantially parallel and separated by a width, and where each side rail includes a front end, a back end, and a body extending between the front end and the back end. The rail system further comprises a storage structure having a length at least as long as the width, a first outside surface adjacent to the body of the first side rail, and a second outside surface adjacent to the body of the second side rail.

In another aspect, a rail system is disclosed. The rail system comprises a first side rail, a second side rail, wherein the first side rail and the second side rail are substantially parallel to each other and are separated by a width, and a storage structure securable to the first side rail and the second side rail. The storage structure comprises a length at least as long as the width, a first side adjacent to the first side rail, a second side opposed from the first side, wherein the second side is adjacent to the second side rail, a first overhang portion extending laterally beyond the first side, a second overhang portion extending laterally beyond the second side, a first plurality of rollers extending outward from the first side towards the first side rail, and a second set of rollers extending outward from the second side towards the second side rail.

In addition to the exemplary aspects and embodiments described above, further aspects and embodiments will become apparent by reference to the drawings and by study of the following detailed description.

### BRIEF DESCRIPTION OF THE FIGURES

Exemplary embodiments are illustrated in the drawings. It is intended that the embodiments and figures disclosed herein are to be considered illustrative rather than restrictive.

FIG. 1 is a perspective view of an example rail system, in accordance with example embodiments.

FIG. 2A is a perspective view of an example rail system, in accordance with example embodiments.

FIG. 2B is a perspective view of an example rail system, in accordance with example embodiments.

FIG. 3 is a perspective view of an example rail system, in accordance with example embodiments.

FIG. 4A is a perspective view of an immobile storage structure, in accordance with example embodiments.

FIG. 4B is a perspective view of a mobile storage structure, in accordance with example embodiments.

FIG. 4C is a perspective view of a disconnected storage structure, in accordance with example embodiments.

FIG. 5 is a cross-sectional view of a storage structure, in accordance with example embodiments.

FIG. 6 illustrates an example mechanism for connecting a storage structure to a side rail, in accordance with example embodiments.

FIG. 7 illustrates an example mechanism for connecting a storage structure to a side rail, in accordance with example embodiments.

FIG. 8 illustrates an example mechanism for connecting a storage structure to a side rail, in accordance with example embodiments.

FIG. 9A illustrates an example side rails and rollers, in accordance with example embodiments.

FIG. 9B illustrates an example side rails and rollers, in accordance with example embodiments.

FIG. 10 illustrates an example mechanism for connecting a storage structure to a side rail, in accordance with example embodiments.

FIG. 11A is a perspective view of an example power equipped rail system, in accordance with example embodiments.

FIG. 11B is a perspective view of an example power equipped rail system, in accordance with example embodiments.

FIG. 11C is a perspective view of an example power equipped rail system, in accordance with example embodiments.

FIG. 11D is a perspective view of an example power equipped rail system, in accordance with example embodiments.

### DETAILED DESCRIPTION

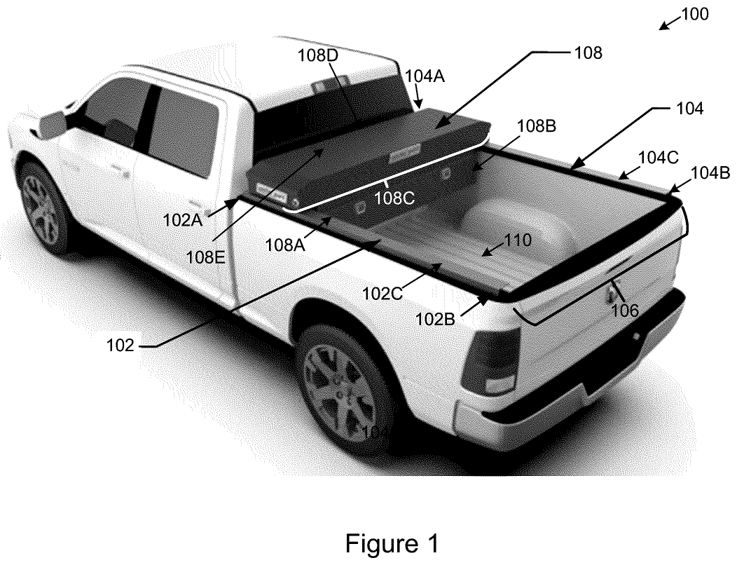

FIG. 1 shows an example rail system 100, according to an embodiment. Rail system 100 includes a first side rail 102, a second side rail 104, and a width 106 that separates the first side rail 102 from the second side rail 104. In some embodiments, the first side rail 102 and the second side rail 104 may be substantially parallel (e.g., completely parallel or within 2 degrees of being parallel). The first side rail 102 may include a front end 102A, a back end 102B, and a body 102C that extends between the front end 102A and back end 102B. Similarly, the second side rail 104 may include a front end 104A, a back end 104B, and a body 104C that extends between the front end 104A and back end 104B.

In example embodiments, an accessory such as a storage structure 108 may be secured to the rail system 100. The storage structure 108 is generally formed from a top, a bottom, and four sides, defining an interior therein. The storage structure 108 has a first side or outside surface 108A that is adjacent to the body 102C of first side rail 102, and a second side or outside surface 108B that is adjacent to the body 104C of second side rail 104. As used herein, the term “adjacent” means no more than 1 foot apart. The outside surfaces 108A and 108B are opposing sides of the storage structure 108. The storage structure 108 also has a third side having length 108C that is at least a long as width 106. A fourth side, 108D, is opposed to the third side 108C. A top 108E may be openable to access the interior of the storage structure 108.

In certain embodiments of the rail system as described herein, the first and second side rails are coupled to the bed of a truck. Such a rail system is shown in FIG. 1, where the first side rail 102 and the second side rail 104 are coupled to the truck bed 110. The coupling might occur via mechanical means (e.g., a mechanical faster, a mechanical screw), adhesive means, or other means.

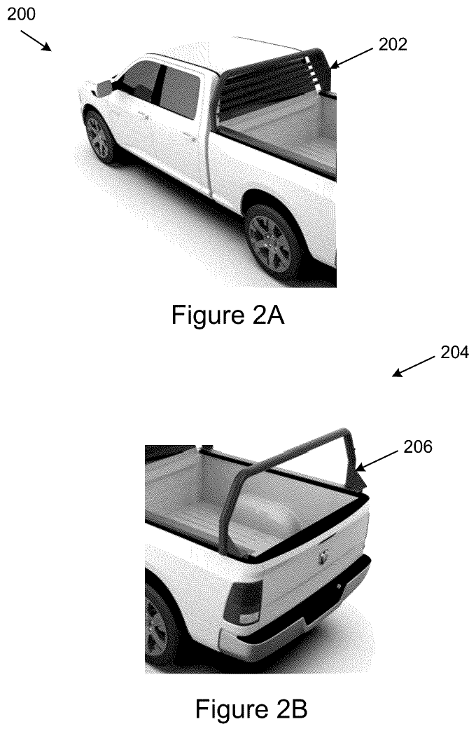

In certain embodiments of the rail system as described herein, the storage structure takes the form of a headache rack. Such a rail system is shown in FIG. 2A, where the rail system 200 is seen with headache rack 202.

In certain embodiments of the rail system as described herein, the storage structure may take the form of a carrying rack. Such a rail system is shown in FIG. 2B, where rail system 204 is seen with carrying rack 206.

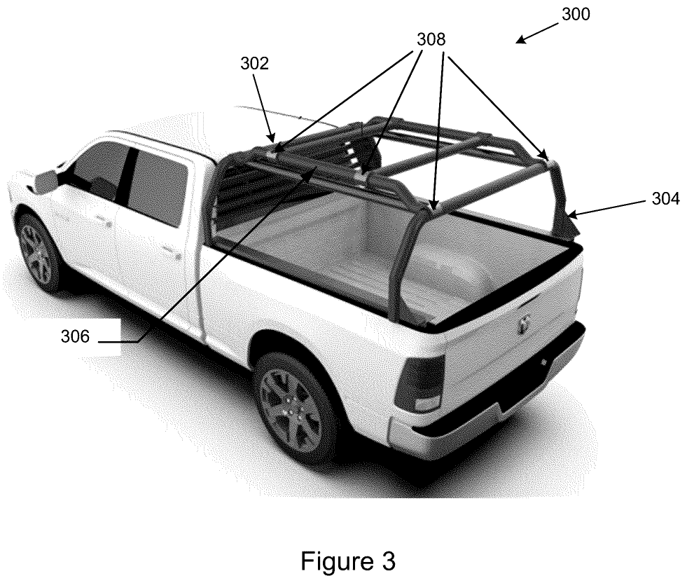

In certain embodiments of the rail system as described herein, a plurality of storage structures may be secured to the rail system. Such a rail system is shown in FIG. 3, where a rail system 300 has both a headache rack 302 and a carrying rack 304 secured thereto. In some embodiments, the plurality of storage structures may be used to support an additional auxiliary structure. For example, in the rail system 300, the headache rack 302 and the carrying rack 304 support an auxiliary structure 306. In some embodiments, one or more of the plurality of storage structures, or the auxiliary structure 306, are equipped with electrically powered lights. For example, as shown in FIG. 3, the auxiliary structure 306 is equipped with lights 308.

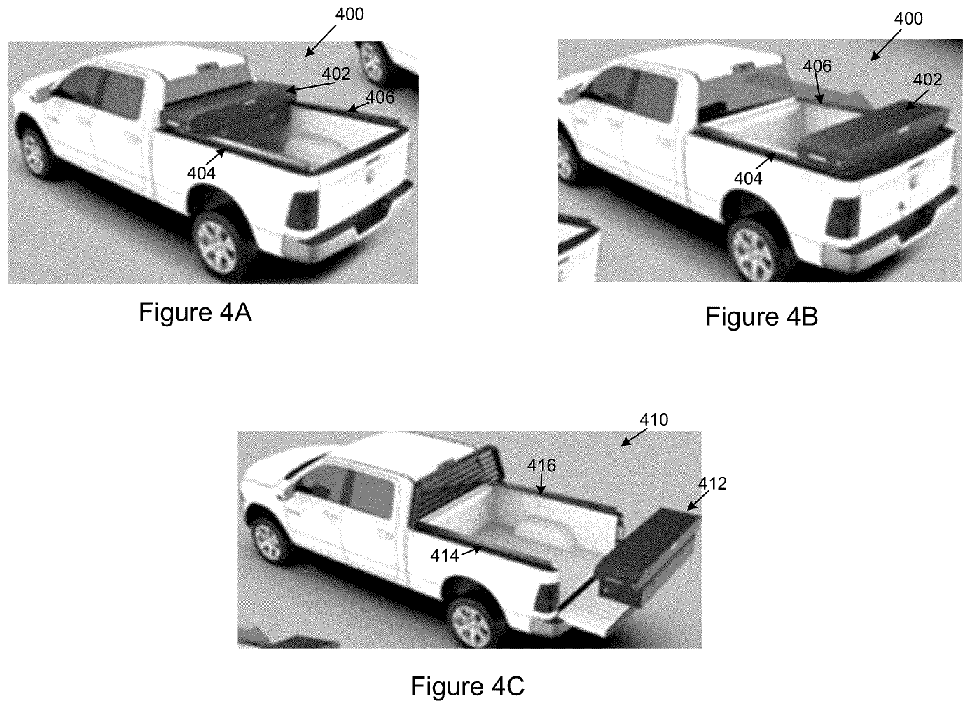

In certain embodiments of the rail system as described herein, the rail system may include a locking or latching mechanism. Such a rail system is shown in FIGS. 4A and 4B, where the rail system 400 includes a storage structure 402 secured thereto, a first side rail 404, and a second side rail 406. FIG. 4A shows a scenario where the locking or latching mechanism is engaged. In such a scenario, the storage structure 402 is immobile and cannot move along first side rail 404 and second side rail 406. In contrast, FIG. 4B shows a scenario where the locking or latching mechanism is disengaged. In such a scenario, storage structure 402 is capable of sliding along the first side rail 404 and the second side rail 406. Example locking or latching mechanisms may include, but are not limited to, toggle friction clamps, spring-loaded plungers which engage notches on the rails 404, 406, or other known locking or latching mechanisms.

In certain embodiments of the rail system as described herein, the storage structure is capable of sliding completely off the side rails. Such a rail system is shown in FIG. 4C, where rail system 410 includes a storage structure 412 secured thereto, a first side rail 414, and a second side rail 416. As shown, the storage structure 412 has completely slid off both the first side rail 414 and the second side rail 416 and is unconnected to first side rail 414 and second side rail 416.

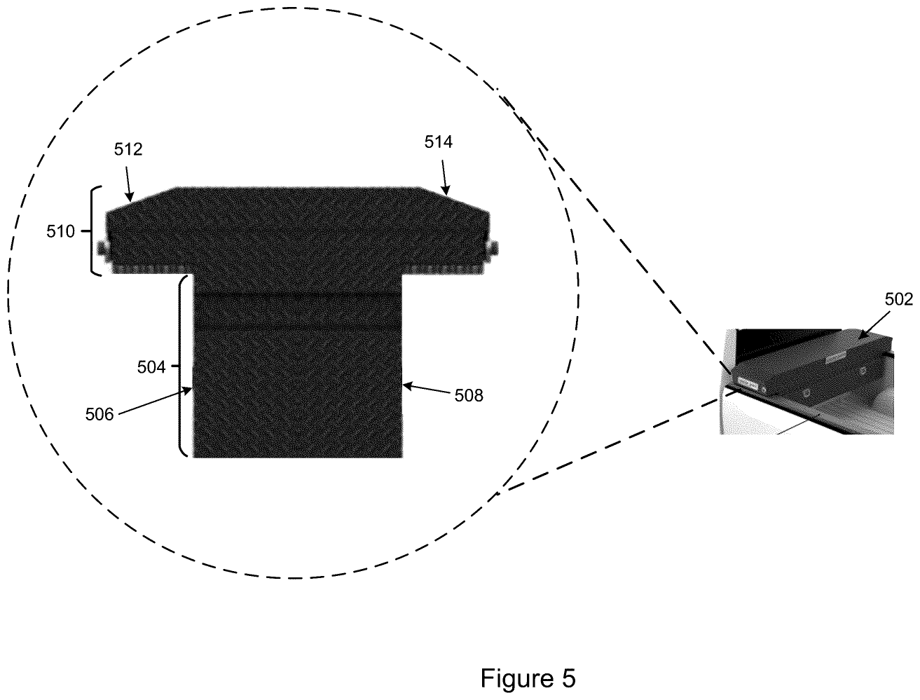

In certain embodiments, the storage structure includes an inner body forming the first and second outside surfaces and an outer body disposed on top of the inner body. An example such storage structure 502 is shown in FIG. 5. As shown in FIG. 5, the storage structure 502 includes an inner body 504 forming a first outside surface 506 and a second outside surface 508, and an outer body 510 disposed on top of or above the inner body 504. The outer body 510 includes a first overhang portion 512 that extends laterally beyond the first outside surface 506 of inner body 504 and a second overhang portion 514 that extends laterally beyond the second outside surface 508 of the inner body 504.

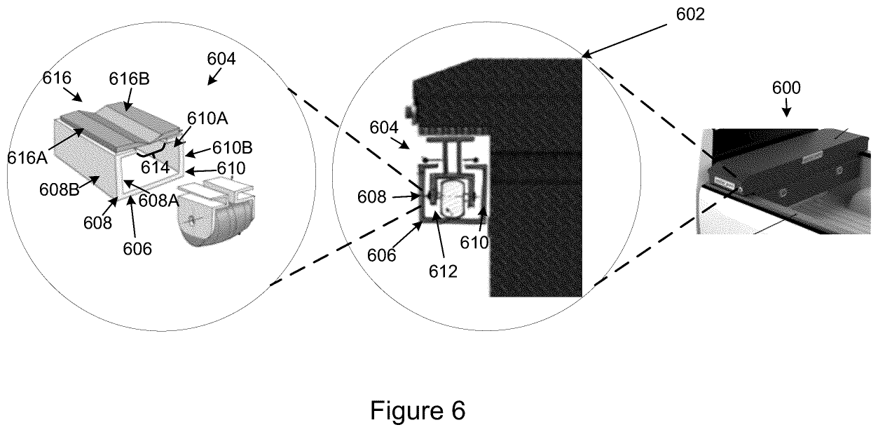

In certain embodiments of the rail system as described herein, the body of each side rail comprises a web and first and second flanges. Such a rail system is shown in FIG. 6, where the rail system 600 includes a storage structure 602 secured thereto and a side rail 604. As shown in FIG. 6, the side rail 604 includes a web 606, a first flange 608, and a second flange 610. The first flange 608 and the second flange 610 each extend outward from the web 606 and toward the storage structure 602. The arrangement of the web 606, the first flange 608, and the second flange 610 is such that they form a channel 612 that spans the length of the body of side rail 604. Moreover, as shown in FIG. 6, the first flange 608 has an inner surface 608A and an outer surface 608B. Likewise, the second flange 610 has an inner surface 610A and an outer surface 610B. On the end opposite web 606, the first flange 608 and the second flange 610 are also separated by a gap 614.

A flexible seal 616 is also shown in FIG. 6, where the flexible seal 616 is shown disposed on the side rail 604. More particularly, the flexible seal 616 includes a first flap 616A disposed on an outer surface 608B of the first flange 608, and a second flap 616B disposed on the outer surface 610B of the second flange 610. In certain embodiments, the flexible seal 616 is capable of being open or closed, where upon being closed, the first flap 616A and the second flap 616B span across the entirety of gap 614, and where upon being open (e.g., in order to receive a roller), the first flap 616A and the second flap 616B do not span across the entirety of gap 614. Note that while in FIG. 6 the flexible seal 616 is shown to be in a closed state, this does not limit flexible seal 616 to that closed state.

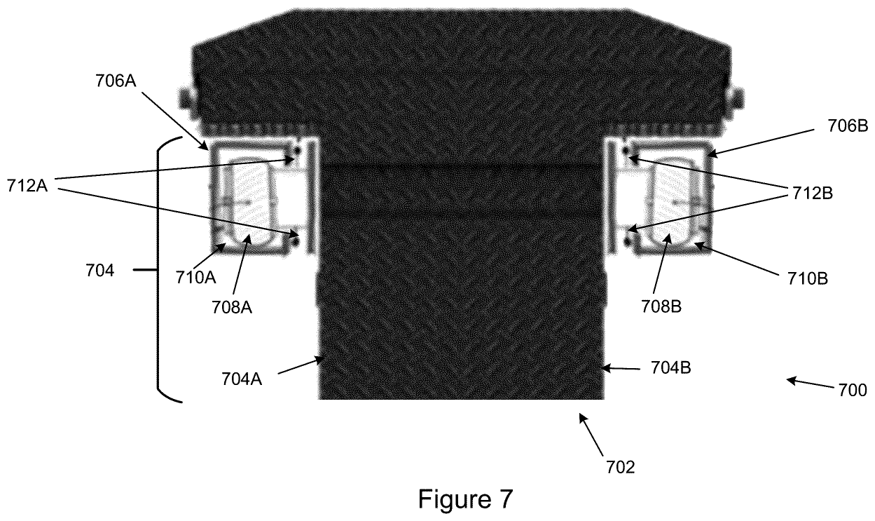

In certain embodiments of the rail system as described herein, the storage structure comprises sets of rollers extending outward from the outside surfaces of the inner body of the storage structure. Such a rail system is shown in FIG. 7, where a rail system 700 includes a storage structure 702 secured thereto, the storage structure 702 having an inner body 704 with a first outside surface 704A and a second outside surface 704B. The rail system 700 includes a first side rail 706A and a plurality of first rollers 708A, which extend outward from the first outside surface 704A towards the first side rail 706A and are disposed within a channel 710A of the first side rail 706A. Similarly, the rail system 700 includes a second side rail 706B and a plurality of second rollers 708B, which extend outward from the second outside surface 704B towards the second side rail 706B and are disposed within a channel 710B of the second side rail 706B. In the embodiments herein, the plurality of first rollers 708A and the plurality of second rollers 708B enable the storage structure 702 to slide along the first side rail 706A and the second side rail 706B. Moreover, in some embodiments, flexible seals 712A and 712B may be disposed on first side rail 706A and second side rail 706B, respectively.

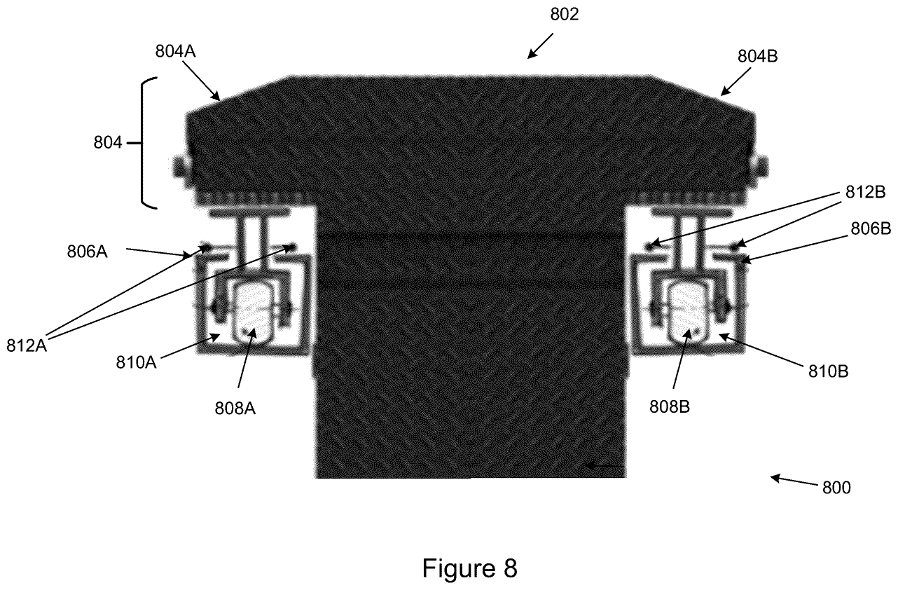

In certain embodiments of the rail system as described herein, the storage structure comprises sets of rollers extending outward from the overhang portions of the outer body of the storage structure. Such a rail system is shown in FIG. 8, where a rail system 800 includes a storage structure 802 having an outer body 804 with a first overhang portion 804A and a second overhang portion 804B. The rail system 800 includes a first side rail 806A and a plurality of first rollers 808A, which extend outward from the first overhang portion 804A towards the first side rail 806A and are disposed within a channel 810A of the first side rail 806A. Similarly, the rail system 800 includes a second side rail 806B and a plurality of second rollers 808B, which extend outward from the second overhang portion 804B towards the second side rail 806B and are disposed within a channel 810B of the second side rail 806B. In the embodiments herein, the plurality of first rollers 808A and the plurality of second rollers 808B enable storage structure 802 to slide along the first side rail 806A and the second side rail 806B. Moreover, in some embodiments, flexible seals 812A and 812B may be disposed on first side rail 806A and second side rail 806B, respectively.

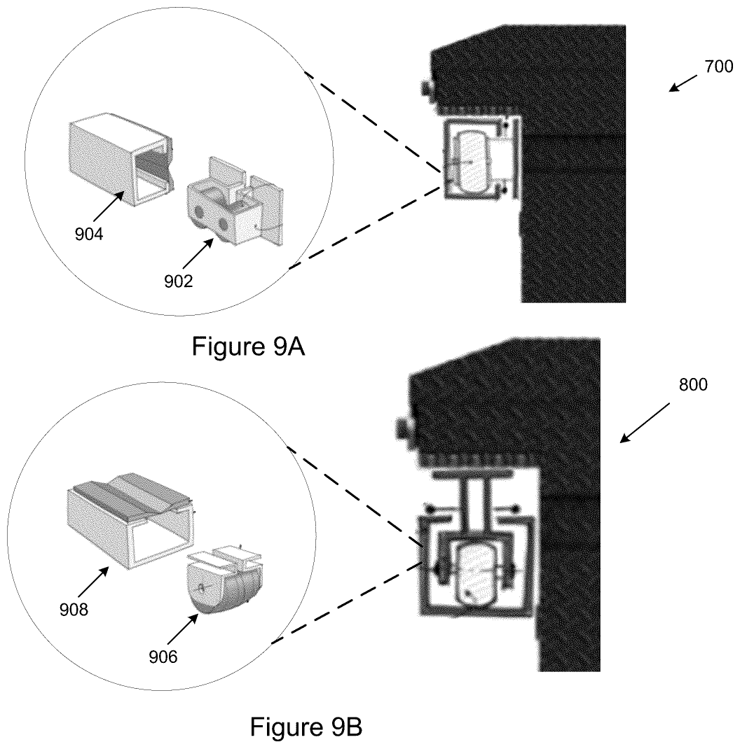

It should be noted that the design of the sets of rollers may be dependent upon the arrangement of the sets of rollers with respect to the storage structure and side rails. For example, as illustrated in FIG. 9A, for arrangements such as in rail system 700, the sets of rollers may take the form of rollers 902 and the side rails may take the form of side rail 904. In contrast, as illustrated in FIG. 9B, for arrangements such as that shown in rail system 800, the sets of rollers may take the form of rollers 906 and the side rails may take the form of side rail 908. Notably, other arrangements, designs, and formats are also possible.

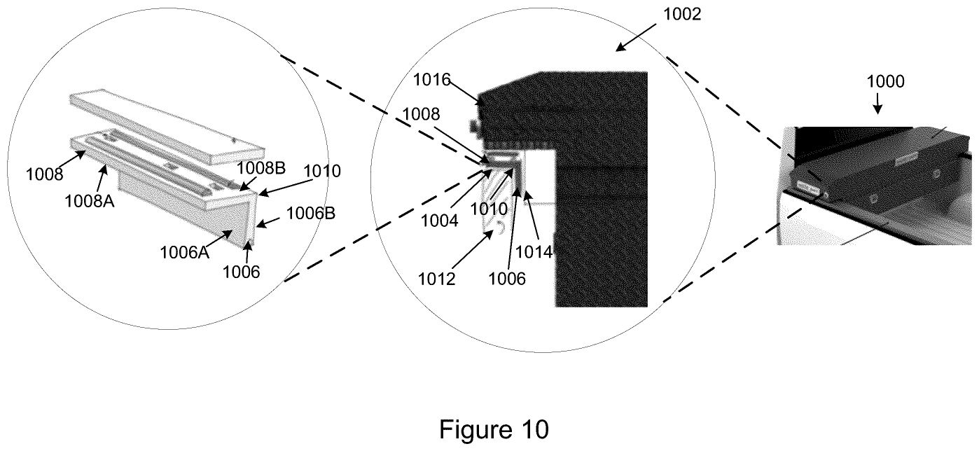

In certain embodiments of the rail system as described herein, the body of each side rail comprises first and second flanges and a corner connecting the first and second flanges. Such a rail system is shown in FIG. 10, where a rail system 1000 includes a storage structure 1002 secured thereto, and a side rail 1004. As shown, the side rail 1004 includes a first flange 1006 and a second flange 1008. The first flange 1006 has an inner surface 1006A and an outer surface 1006B. The second flange 1008 has an inner surface 1008A and an outer surface 1008B. The first flange 1006 and second flange 1008 are connected or attached by a corner 1010. In some embodiments, the first flange 1006, the second flange 1008, and the corner 1010, are integrally formed.

In certain embodiments, the inside surfaces of the first and second flanges are connected to a bed of a truck. For example, as shown in FIG. 10, the inside surfaces of the first flange 1006 and the second flange 1008 are connected to a truck bed 1012.

In certain embodiments, the outer surfaces of the first flanges are substantially contiguous with the inner body of the storage structure. For example, as shown in FIG. 10, the outer surface of first flange 1006 is substantially contiguous (touching or within 1 foot of touching) with inner body 1014 of storage structure 1002.

In certain embodiments, the outer surface of the second flanges are substantially contiguous with the overhang portions of the outer body of the storage structure. For example, as shown in FIG. 10, the outer surface of second flange 1008 is substantially contiguous (touching or within 1 foot of touching) with the overhang portion 1016 of the storage structure 1002.

In certain embodiments of the rail system as otherwise described herein, the outer surface of the second flanges is made from a low friction material. In some embodiments, the low friction material is nylon. In some other embodiments, the low friction material is Teflon™.

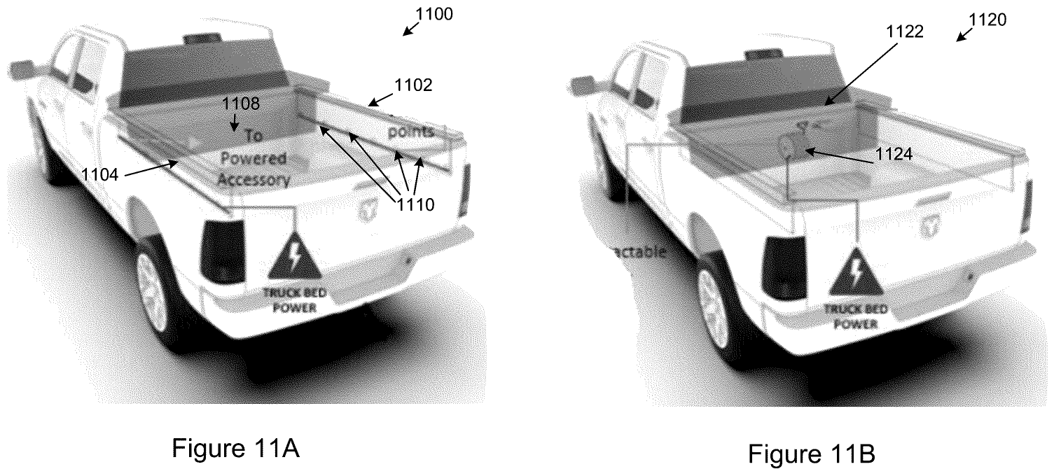

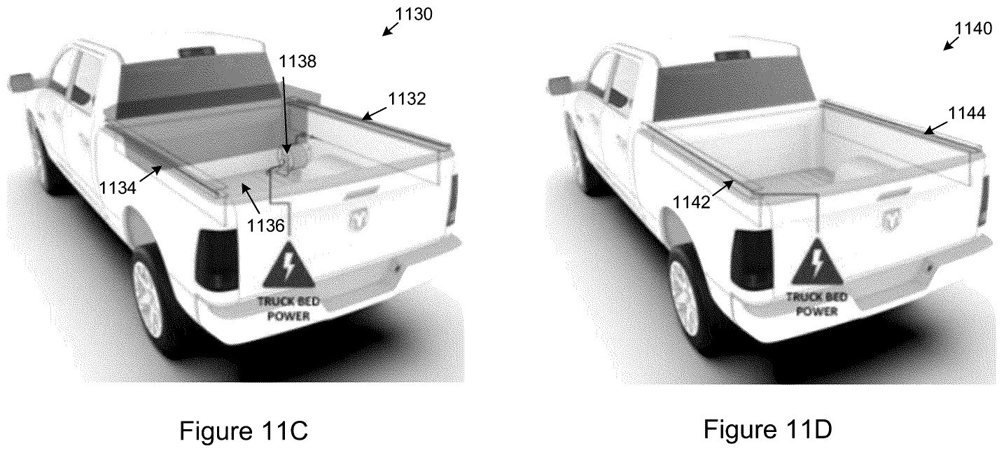

In certain embodiments of the rail system as described herein, the rail system includes an electrical power source. Such a rail system is shown in FIG. 11A, where a rail system 1100 includes a first side rail 1102 and a second side rail 1104. As shown, the first side rail 1102 and the second side rail 1104 are coupled to the truck bed 1108. In turn, the truck bed 1108 contains a series of sockets 1110 along portions of the truck bed 1108 that are connected to first side rail 1102 (although not shown, similar sockets may be placed along the portions of truck bed 1108 that are connected to second side rail 1104). The sockets 1110 may be operable to provide electrical power to other devices. For example, the sockets 1110 may take the form of 120V AC outlets which could be used to power tools, cooling units, battery chargers, or other devices.

In certain embodiments of the rail system as described herein, the electrical power source takes on the form of a retracting reel mounted within the storage structure. Such a rail system is shown in FIG. 11B, where a rail system 1120 includes a storage structure 1122 secured thereto. As shown, a retracting reel 1124 is disposed within the storage structure 1122. The retracting reel 1124 may take the form of an electrically powered cable that can be extended in order to connect to a desired accessory. In example embodiments, the retracting reel 1124 may derive its power from an independent battery source (e.g., a portable power generator) or from the engine of the truck to which the truck bed is attached.

In certain embodiments of the rail system as otherwise described herein, the electrical power source takes on the form of a retracting wheel that is mounted on the truck bed. Such a rail system is shown in FIG. 11C, where a rail system 1130 includes a first side rail 1132 and a second side rail 1134. As shown, the first side rail 1132 and the second side rail 1134 are coupled to a truck bed 1136. In turn, the truck bed 1136 contains a retracting reel 1138, which may take the form of an electrically powered cable that can be extended in order to connect to a desired accessory. In example embodiments, the retracting reel 1138 may derive its power from an independent battery source (e.g., a portable power generator) or from the engine of the truck to which the truck bed is attached.

In certain embodiments of the rail system as otherwise described herein, the side rails can provide electrical power to other devices upon the other devices becoming electronically coupled to the side rails. Such a rail system is shown in FIG. 11D, where a rail system 1140 includes a first side rail 1142 and a second side rail 1144. As shown, electrical power (i.e., from a portable power generator or from the engine of a truck) is supplied directly to the first side rail 1142 and the second side rail 1144. In turn, accessories equipped with electrical contacts can attach to the first side rail 1142 and the second side rail 1144 in order to receive power.

It should be noted that rail systems 100, 200, 204, and 300, 400, 410, 600, 700, 800, 900, 1100, 1120, 1130, and 1140 can include some or all of the functions or elements described in connection with each other.

While a number of exemplary aspects and embodiments have been discussed above, those of skill in the art will recognize that still further modifications, permutations, additions and sub-combinations thereof of the features of the disclosed embodiments are still possible. It is therefore intended that the following appended claims and claims hereafter introduced are interpreted to include all such modifications, permutations, additions and sub-combinations as are within their true spirit and scope.

1. A rail system comprising:
first and second side rails, wherein the first and second side rails are substantially parallel and separated by a width, and wherein each side rail includes:
a front end,
a back end, and
a body extending between the front end and the back end; and
a storage structure securable to the first side rail and the second side rail, the storage structure comprising:
a length at least as long as the width,
a first outside surface adjacent to the body of the first side rail, and
a second outside surface adjacent to the body of the second side rail.

2. The rail system of claim 1, wherein the first and second side rails are coupled to a bed of a truck.

3. The rail system of claim 1, wherein the storage structure is a truck bed.

4. The rail system of claim 1, wherein the storage structure is a headache rack.

5. The rail system of claim 1, wherein the storage structure is a carrying rack.

6. The rail system of claim 1, further comprising a locking mechanism, wherein when the locking mechanism is disengaged, the storage structure is capable of sliding along the body of the side rails, and wherein when the locking mechanism is engaged, the storage structure is prevented from sliding.

7. The rail system of claim 1, wherein the storage structure includes:
an inner body forming the first and second outside surfaces; and
an outer body disposed on top of the inner body and including:
a first overhang portion extending laterally beyond the first outside surface of the inner body, and
a second overhang portion extending laterally beyond the second outside surface of the inner body.

8. The rail system of claim 7, wherein the body of each side rail comprises:
a web; and
first and second flanges separated by a gap, each of the first and second flanges extending outward from the web towards the storage structure and having an inner surface and an outer surface;
whereby the web, the first flanges, and the second flanges form a channel spanning the length of the body.

9. The rail system of claim 8, wherein the body of each side rail further comprises a flexible seal including:
a first flap disposed on the outer surface of the first flange; and
a second flap disposed on the outer surface of the second flange.

10. The rail system of claim 9, wherein the flexible seal is capable of being open or closed, wherein upon being closed, the first and second flaps span across the gap, and wherein upon being open, the first and second flaps do not span across the gap.

11. The rail system of claim 8, wherein the storage structure comprises:
a first set of rollers extending outward from the first outside surface towards the first side rail and disposed within the channel of the first side rail; and
a second set of rollers extending outward from the second outside surface towards the second side rail and disposed within the channel of the second side rail.

12. The rail system of claim 8, wherein the storage structure further comprises:
a first set of rollers extending outward from the first overhang portion towards the first side rail and disposed within the channel of the first side rail; and
a second set of rollers extending outward from the second overhang portion towards the second side rail and disposed within the channel of the second side rail.

13. The rail system of claim 7, wherein the body of each side rail comprises:
first and second flanges, each flange having an inner surface and an outer surface; and
a corner connecting the first flange and the second flange.

14. The rail system of claim 13, wherein the inner surfaces of the first and second flanges are connected to a bed of a truck.

15. The rail system of claim 13, wherein, for each side rail, the outer surfaces of the first flanges are substantially contiguous with the inner body of the storage structure.

16. The rail system of claim 13, wherein, for each side rail, the outer surfaces of the second flanges are substantially contiguous with the overhang portions of the outer body of the storage structure.

17. The rail system of claim 16, wherein the outer surface of the second flanges is made from a low friction material.

18. The rail system of claim 17, wherein the low friction material is nylon or Teflon™.

19. The rail system of claim 1, wherein the sides rails are attached to electrical power source, and wherein the sides rails can provide electrical power to other devices upon the other devices becoming electronically coupled to the side rails.

20. A rail system comprising:
a first side rail;
a second side rail, wherein the first side rail and the second side rail are substantially parallel to each other and are separated by a width; and
a storage structure securable to the first side rail and the second side rail, the storage structure comprising:
a length at least as long as the width,
a first side adjacent to the first side rail,
a second side opposed from the first side, wherein the second side is adjacent to the second side rail,
a first overhang portion extending laterally beyond the first side,
a second overhang portion extending laterally beyond the second side,
a first plurality of rollers extending outward from the first side towards the first side rail; and
a second set of rollers extending outward from the second side towards the second side rail.
